(19) United States
(12) Patent Application Publication
(10) Pub. No.: US 2004/0010628 A1
(43) Pub. Date: Jan. 15, 2004

(54) System and method for discouraging unauthorized duplication of data stored on a storage media

(76) Inventors: Richard J. Gillam, Aliso Viejo, CA (US); William W. Hosek, Laguna Niguel, CA (US)

Correspondence Address: Mark Bologh, Director of Marketing, DeskSite, Inc., 2681 Kelvin Avenue, Suite 127, Irvine, CA, 92614, US

(21) Appl. No.: 10/281,890

(22) Filed: Oct. 28, 2002

Related U.S. Application Data
(63) Continuation-in-part of application No. 10/194,990, filed on Jul. 11, 2002.

(51) Int. Cl. G06F 15/16

(52) U.S. Cl. 709/250

(57) ABSTRACT

Systems and methods for discouraging unauthorized duplication of storage media are described. A client device is connectable to a network which is connected to a server device. The storage media may contain one or more data files stored on the storage media. The data files are capable of being read by a storage media reader contained in or connected to one of the client devices. The client device may receive updated network data from a server device as a result of using the storage media containing the data files. To prevent the downloading of the updated network data to more than one client after unauthorized duplication of the storage media, an identification number stored on the storage media is transmitted to the server device wherein only the last client device that transmitted the identification number to the server device in time should receive updated network data.

### RELATED APPLICATIONS

This application is a continuation in part of Ser. No. 10/194,990 filed Jul. 11, 2002.

### FIELD OF THE INVENTION

The invention relates to a system and method for discouraging unauthorized duplication of data stored on a storage media. More particularly, the invention relates to a system and method in which an identification number is stored on the storage media for transmitting to a server device to notify the server device that only the client device transmitting the identification number should receive updated network data.

### DESCRIPTION OF THE PRIOR ART AND RELATED INFORMATION

The Internet has provided access to information by the general and business public far beyond what was dreamed of before proliferation of the Internet. This global network has enjoyed much success in terms of usage, even before wide-band access started to become more widely available.

In the days before significant proliferation of wide-band access to the Internet, typical users were confined to access speeds of 56K bits/second and lower. However, at least with respect to developed and developing areas of the World, wide-band access has become more available. It was largely felt that wide-band access would solve most of the problems associated with slow or sporadic access provided by conventional modulation of analog signals in the telephone network.

However, the growing proliferation of wide-band access to the Internet has caused many new problems. Internet servers that more or less were able handle the comparatively low access rates by users before wide-band access started to dramatically increase are now either overtaxed, or their owners have had to endure expensive upgrades that will soon again become obsolete as more users obtain wide-band access. This problem is largely due to the generally accepted design of Internet server-client relationship, which typically provides for a centralized system wherein the server does most of the processing, handling both database and presentation operations on the server, and then downloading full presentation pages in hypertext markup language (HTML), or created by the server using dynamic HTML (DHTML), CGI, or ASP or otherwise, down to each client, the client computer acting more as a “thin client” terminal with a browser to display downloaded pages.

Many companies, such as The Oracle Corp. of Redwood Shores, Calif., have married themselves to the centralized model. Those companies are pushing for a move toward “network computers” that comprise thin client computers with reduced client resources wherein most of the processing is performed at the server computer on-line. It has even suggested that local running applications should largely be eliminated, utilizing remotely-stored applications. That will only add to the problem. Network servers will continue to be overtaxed, and even wide-band users will see significant slow-downs in processing due to the growing bottlenecks on the server side.

Another significant problem is that users that are married to their wide-band access are disillusioned when they leave their homes and offices to travel. Those mobile users are again stuck with relatively slow and inefficient 56K modems to access the Internet and other networks such as their office networks. Again, the current move by the industry, teaching away from the use of now very cheap and thick clients with major processing power compared to even five years ago is the root of this problem.

It would thus be advantageous to provide a system that provides for most processing to be performed, even business or consumer transactions, without the need of a constant wide-band connection to the Internet. The system of the present system provides such a system, even allowing business and consumer transactions to be performed in the absence of any connection to a network at all.

### SUMMARY OF THE INVENTION

Systems and methods for completing a transaction are described. A client device is connectable to a network. The client device is configured to process a transaction off-line or on-line to create completed transaction data. A data manager, or controller, is provided for sensing a network connection to the network and for transmitting the completed transaction data to the server device if a network connection is sensed by the data manager. The client device is further configured to receive confirmation data from the server device indicating that the server device received the completed transaction data. The confirmation data comprises output data indicating that the transaction completion data was successfully received by the server device.

The indicator may comprise an icon on the client device configured to change appearance for indicating that the confirmation data is received. Alternatively, other indicators may be used, such as an audible signal presented on the client device, by electronic mail to a specified recipient, or by providing a digital page to a pager.

A dynamically generated form may be generated on the client device in order to process the transaction. The dynamically generated form may comprise a DHTML-based form. Using input devices attached to the client device, the client device receives input to combine with the dynamically generated form.

Another aspect of the invention comprises a system and method for receiving updated network data. The client device is configured to request and receive network data from and to the server device. A data manager senses a network connection to the network. Network data is updated by receiving updated network data. An indicator for indicating that the updated network data is received is provided. Viewable, audible, or other types data may be dynamically rendered based on the network data and the updated network data.

Another aspect of the invention comprises a system on a client device for receiving a data set from a server device. A communications device for providing a communications channel for receiving two or more portions of the data set is included. A storage medium is included for storing each of the two or more portions of the data set as each portion is received. A controller is provided for monitoring the usage of the communications channel. The controller is further for interrupting the reception of the portions of the data set if the monitored usage reaches a threshold. The controller is further for re-starting reception if the monitored usage falls below the threshold. The controller is further for determining the next portion of the data set to be received based on the number of portions of the data set that were received before the reception of the portions was interrupted. The data set may comprise a file or other types of data for reception by the client device. A command queue may further be provided in the client device. The command queue is configured to receive a transfer command for processing by the controller to request the data set from the server computer.

Another aspect of the invention is a system and method for a server device to transmit a data set to a client device. A communications device is included for providing a communications channel with the client device for transmitting two or more portions of the data set. A controller is provided for including each portion into a packet. The packet is capable of containing both at least one of said portions and other data. The packet may comprise an XML document.

The system may also be used for discouraging unauthorized duplication of storage media. The storage media may contain one or more data files stored on the storage media. The data files are capable of being read by a storage media reader contained in or connected to one of the client devices. The client device may receive updated network data from a server device as a result of using the storage media containing the data files. To prevent the downloading of the updated network data to more than one client after unauthorized duplication of the storage media, an identification number stored on the storage media is transmitted to the server device wherein only the last client device that transmitted the identification number to the server device in time should receive updated network data.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high level block diagram illustrating a system that can be used for completing a transaction;

FIG. 2 is a block diagram illustrating components of the client device of FIG. 1;

FIG. 3 is a block diagram illustrating components of the server device of FIG. 1;

FIG. 4 is a block diagram illustrating a packetized protocol that can be used for communication between a sever device and a client device; and

FIG. 5 is a flow diagram illustrating steps performed by the client device of FIG. 1 for completing a transaction.

### DETAILED DESCRIPTION OF THE PREFERRED EMBODIMENTS

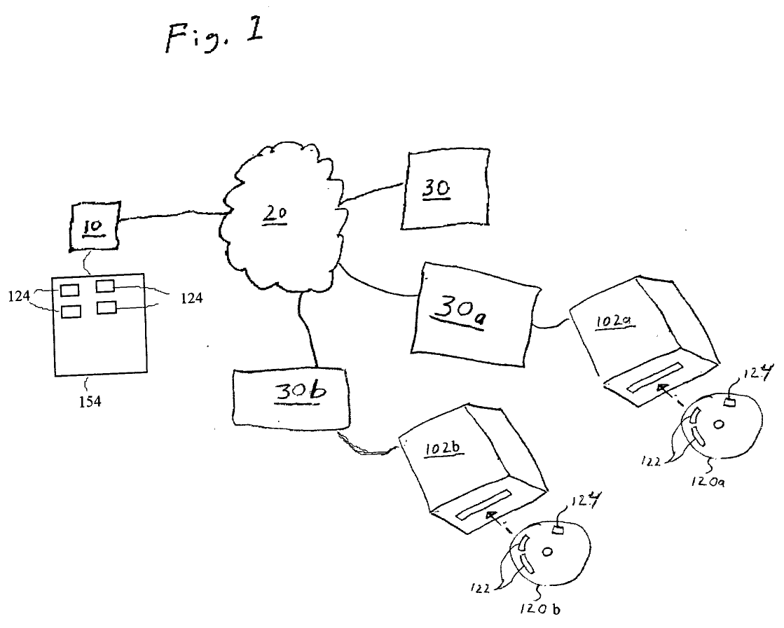

With reference to FIG. 1, a high level block diagram illustrating a system that can be used for completing a transaction is shown. A client device 10 is connectable to a network 20. The client device 10 may comprise any one of a number of electronic devices capable of processing, transmitting and receiving data, including, but not limited to, a personal computer, personal digital assistant (PDA), wireless phone, interactive cable television set-top box and television, interactive satellite television system, or any other system capable of receiving input and displaying output, and receiving and transmitting data over the network 20. Accordingly, the network 20 may comprise any combination of terrestrial or wireless networks, including, but no limited to, the Internet, wireless cellular, satellite, microwave, or any other network capable of transmitting data. Further, the network 20 may comprise a local area network (LAN), wide area network (WAN), or a combination thereof.

A server device 30 is connected to the network 20. The server may similarly comprise one or more of several types of electronic devices, including, but not limited to, a large mainframe computer, mid-range computer, multiple processing computer, a cluster of computers, or a personal computer.

The client device 10 is configured to process a transaction either on-line or off-line to create completed transaction data. The transaction data may comprise, for example, banking data, catalog purchase data, financial market transactions such as buy orders or sell orders, or any other type of transaction that can be conducted with the server device 30.

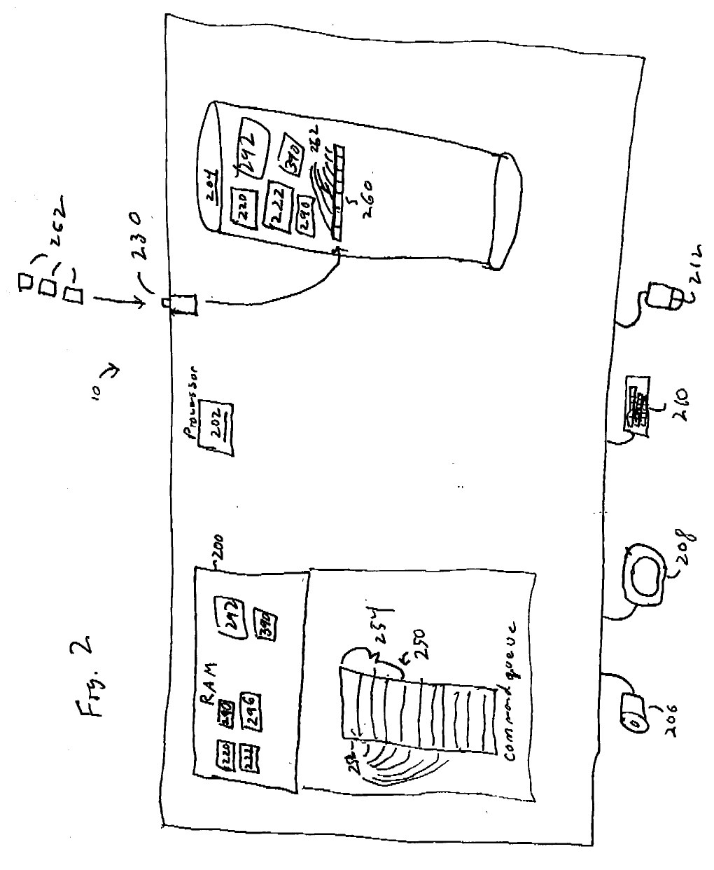

With reference to FIG. 2, a block diagram illustrating components of the client device 10 is shown. In one embodiment, the client device 10 comprises a personal computer. The client device 10 comprises one or more processors 202, and a volatile storage device 200 such as a random access memory device for temporary storage of executing programs and data. The client device 10 further includes a non-volatile storage device 204 such as a hard disk device or non-volatile solid-state memory device. Also included is an audio device 206, such as a speaker system, and a display device 208, such as a cathode ray tube (CRT) or liquid crystal display (LCD). The client device 10 may further include input devices such as a keyboard 210 and a mouse 212. The display 208 may also comprise a touch-pad such as that of a PDA to serve as an input device as well. An appropriate network interface 230 is included for connecting the client device 10 to the network 20. The network interface 230 may be one of several types depending on the type of network 20 (FIG. 1) that the client device 10 is configured to use. For example, a wireless Eithernet adapter may comprise the network device 230 if the network 20 is of IEEE 802.11 x or BLUETOOTH wireless type.

A data manager or controller 220 may comprise a software program executable on the processor 202. The data manager 220 is stored in the non-volatile storage device 204, and loaded into volatile storage 200 during operation of the system of the present invention. As one of its functions, the data manager 220, also called a content management agent or controller, manages transactions and data elements that are processed by the client device 10 and transmitted to the server device 30.

A user of the client device 10 may input data for a transaction using the input devices 210 and 212. The whole transaction is processed on the client device 10 without regard to whether a connection to the network is active, with the user using the input devices 210 and 212 to input data, which may be displayed on the display device 208. Audio instructions may be provided using the audio device 206 to aid in the input process.

For example, if the transaction to be processed is a banking transaction, such as a transfer from one account to another, then the client device 10 may load an HTML form, or, preferably a DHTML form 222 as described below, from the storage device 204 into the RAM 200. A DHTML compliant browser is also loaded into RAM 200 from the storage device 204 in order to process the loaded form and display it on the display device 208 for user input. Part of the DHTML form 222 may include audio instructions for presentation on the audio device 206 for instructing the user in completing the transfer transaction.

In the system of the present invention, the DHTML form 222 is stored and rendered into a browser solely on the client device 10 in order to allow for both on-line and off-line transactions. A DHTML rendering system 292, much like DHTML servers that are used on server computers for multiple users, is used as a single-user type DHTML “local” server on the client device 10 in order to process both on-line and especially off-line transactions. In this way, the DHTML form 222 may thus be rendered and operate on the device to process both on-line and off-line transactions. As with typical server based DHTML forms, the input devices 210 and 212 receive input from the user that is put into fields in the DHTML form 222 and received using the DHTML form 222 for processing the transaction.

After the transaction is completed by the user on the client device 10, a set of completed transaction data 290 is created as a result of the transaction. Preferably, the completed transaction data 290 only includes data that is essential to the transaction, and not any ancillary DHTML form 222 data such as display graphics or instructions to the user. The completed transaction data 290 is stored on the non-volatile memory device 204 to await transmission to the appropriate server 30 for remote processing of the completed transaction data 290.

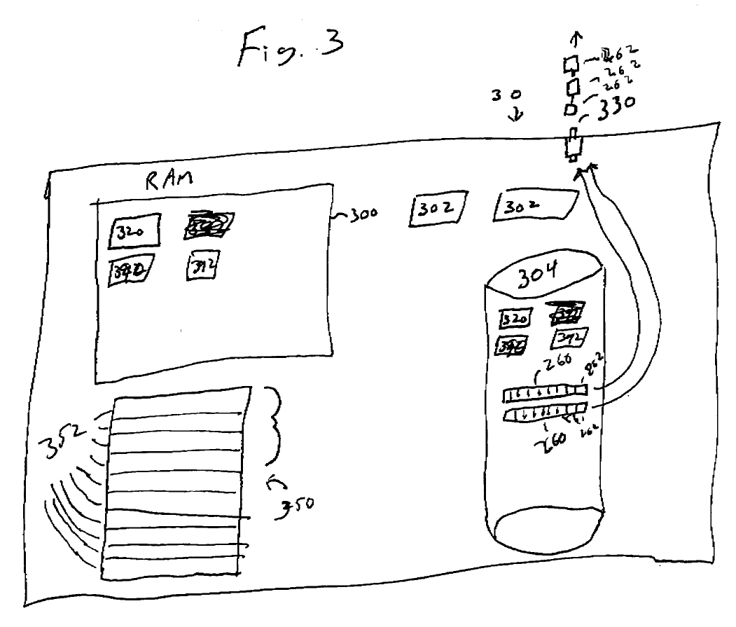

The data manager senses whether there is a network connection to the network 20. The data manager accesses the appropriate levels of the open system interconnection (OSI) model being used by the client device 10 and network interface device 230 to determine if a connection can be made to the server device 30 through the network 20. If there are one or more completed transaction data sets 290 stored on the non-volatile storage device 204 awaiting transmission, then the data manager 220 continuously or periodically polls the operating or communication system of the client device 10 to sense a network connection. In some embodiments, the data manager 220 may attempt to initiate a network connection if one does not exist. Whether a network connection is sensed by the data manager 220 or not, for all intent and purposes, the user has completed the transaction with the creation of the completed transaction data 290. Once a network connection is sensed, and at a point where either the data manager on the client device 220 or the data manager 320 (FIG. 3 below) on the server device 30 determine that the proper priority level for transmission of the completed transaction data 290 is high enough with respect to other local or network tasks being processed on the client device 10 and/or the server device 30, the client device 10 transmits the completed transaction data 290 to the server device 30.

With reference to FIG. 3, a block diagram illustrating components of the server device 30 is shown. In the illustrated embodiment, the server device 30 comprises a mid-range or high-end personal computer. Similarly to the client device 10 of FIG. 2, the server device 30 includes one or more processors 302, a volatile storage device 300 such as a RAM, and a nonvolatile storage device 304 such as a hard disk drive. Stored on the non-volatile storage device 304 is a data manager 320 for the server device 30, which is loaded into the volatile storage device 300 during operation of the server device 30. A network interface 330 is also included for connecting to the network 20 similar to that of the client device 10. Preferably, the server device 30 includes several network interfaces 330 for increased bandwidth. However, as explained below, the system of the present invention may include many bandwidth saving features such that less network connections are necessary when compared to typical systems.

Once the server device 30 receives the completed transaction data 290, the server device 30 processes the completed transaction data to the extent that processing is needed depending on the transaction type. For example, with respect to the above described banking transaction, the completed transaction data 290 comprises a transfer order, wherein the server device 30 connects to the appropriate account records for the user, and the transfer is then processed by debiting the account from which the user ordered the transfer, and crediting the account to which the user placed the transferred amount.

Once the server device 30 has received and processed the completed transaction data 220, the data manager 320 of the server device 30 creates confirmation data 322 for transmitting to the client device 10. The confirmation data 390 is data that confirms that the server device 10 has received the transaction completion data 290, and successfully processed that data to the extent that it needs to be processed. Some transaction completion data 290, for example, does not need to be further processed by the server device and may just comprise, for example, data that is merely stored in the non-volatile storage device 304. In that case, the confirmation data 390 would merely comprise data to notify or indicate to the client device 10 that the transaction completion data 290 had been stored in the server device 30.

The client device 10 is configured to request and receive network data, comprising any type of data that can be received by the client from the server device 30 and other nodes and server devices 30 connected to the network 20. Further, the client device 10 may update the network data by receiving updated network data. Similarly, the updated network data may be for updating data related to the transaction performed by the user. Hence, the updated network data may comprise the confirmation data 290.

Further the system may perform dynamically rendering of viewable, audible, or other types data based on the network data and the updated network data. Such dynamic rendering may be accomplished using DHTML forms 222 as described above. The DHTML forms 222 may be included in network data or the updated network received by the client device from a server device 30. The DHTML forms 222 may be used to render browser pages incorporating input data, network data and updated network data. The DHTML forms 222 are stored in the non-volatile storage device 204. The updated network data may comprise the aforementioned confirmation data 290. For example, the DHTML form 222 may comprise the graphics for the notification screen to indicate reception of the confirmation data 290, which is viewed within a DHTML form 222 when loaded into RAM 200 and displayed.

In order to facilitate reception of the confirmation data 290, the data manager 220 executing on the client device 10 senses the network connection to the network 20. The client device 10 may then receive the confirmation data 390 from the server device 30 indicating that the server device 30 received the completed transaction data 390. The confirmation data 390 may, for example, comprise output data indicating that the transaction completion data 290 was successfully received by the server device 30. Further, the data manager may trigger or display an indicator on the client device for indicating that the updated network data or confirmation data 390 was received from the server device 30. The indicator may comprise, for example, an icon on the client device configured to change appearance for indicating that the confirmation data 390 is received. There are many systems that typically provide a means for changing the characteristics of a screen icon, including animated icon add-ons from various companies, including from Westcoast Icons and Design Ltd. of Victoria, British Columbia, Canada.

Similarly, with respect to any kind of network data and updated network data as described above, the indicator comprising the icon displayed on the client device 10 may be configured to change appearance to indicate that the updated network data is received. The change in appearance of the icon may, for example, comprise a change from a static icon into a flashing icon. Alternatively, the indicator may comprise an audible signal presented on the client device to indicate that updated network data (e.g. confirmation data) is received. Other indicators may be used or triggered by the system, such as an electronic mail to a specified recipient, or by providing a digital page to a pager.

With reference back to FIG. 2, in another aspect of the system of the present invention, the communications device on the client device 10 provides a communications channel for receiving files or data sets 260 in general. A file 260 may have two or more portions 262. For example, a file 260 may be considered as a series of portions 262 that can be transmitted and received separately. The portions 262 may be of any size, including, but not limited to, 1 byte, 4 bytes, 16 bytes, 28 bytes, 1 kilobyte, 1024 kilobytes, 28 kilobytes or other sizes. As each portion 262 of the file 260 is received, it is stored in a storage medium, such as the nonvolatile storage device 204 in of FIG. 2.

In this context, the data manager 220 can also act as a controller for monitoring the usage of a communications channel to the network, which comprises the network interface 230 and related software to operate with the network 20. The monitored usage, for example, may comprise the quantity of data over time transmitted or received, either in bytes or packets. The controller 220 may inhibit or interrupt the reception of the portions of the file 262 if a monitored usage of the communication channel reaches a threshold. As operations continue on the client device 10 while the file 260 is being downloaded, including the transmission and downloading of other files 260 from and to the server device 30, controller 220 monitors the operations, makes a determination of priority for each operation based on the type of operation, and determines whether downloading of the portions 262 is high enough in priority to continue. The controller 220 may be programmed so that the levels of priorities are in a matrix 296 stored in the volatile storage device 200 loaded from the nonvolatile storage device when operation of the controller 220 begins. The priority level of each transaction is based on the type of transaction. For example, in the matrix, a stock trade transaction, which may be highly time sensitive by the minute, may be granted a higher priority level than a transaction to download a video for viewing at a later time. If the trade needs to be performed, and the video is downloading, the controller assess the bandwidth being used in the communication channel, and the controller 220 may stop reception of the file portions 262 before all of the file portions 262 for a particular file is downloaded. Once the high-priority trade has been executed, the controller, reads the number of portions of the file 260 that have been downloaded into the non-volatile storage device 204 based on the size of the partially downloaded file, and re-starts reception of the portions 262 of the file 260. In other words, if the monitored usage of the communication channel falls below a threshold, the controller 220 determines the next portion 262 of the file or data set 260.

This priority system may be implemented using a command queue 250, which may be controlled by the controller 220. For example, there may be a relatively finite number of processes or network related processes that may be initialized to run on the client device 10 concurrently. The command queue may store entries 252 for each of the currently running and pending processes of the client device 10. The entries are entered by software applications running on the client device 10. The command queue 250 is sorted based on priority of the entries 252 and therefore the priority of the processes. The controller is programmed to determine the number of processes or network processes that may be currently executing on the client device 10. This determination may be based on system resources available for executing the processes, e.g. processor usage and memory usage. The controller may, for example, determine that only the top four processes may execute concurrently. Thus, only the processes that have entries 252 in the command queue that are one of the top four will execute, while the other lower priority processes must wait for one of the top four processes to terminate. Ties in priority are ordered by the time of entry into the queue.

If a new entry 252 is entered into the queue 250 by a software application, wherein that entry 252 has a priority higher than any of the four entries for the processes currently executing, the new entry 252 is entered in order, causing the previously fourth highest entry 252 in the queue 252 to be placed in the fifth position. Once any entry 252 for a process falls below the number of priority levels for execution of its related process, that related process is suspended until the corresponding entry 252 is moved back up into the top entries 252 for executing. Meanwhile, the process related to the new entry 252 begins executing.

One of the entries 252 in the command queue 250 may comprise a file transfer command, which is an entry designating a process for the transfer of a file 260 process in portions 262 as described above. The interruption in transferring the portions 262 of the file 260 takes place when the file transfer command entry 252 falls below the top executing entries 252. The transfer of the portions 262 of the file 260 is re-started as described above when the file transfer command entry 252 is moved back up into the top executing entries 252.

As described above, the controller 220 monitors the usage of the communications channel, and/or system resources, to determine the initial number of processes that may be executing concurrently, and therefore the number of entries 252 in the command queue 250 that are members of the top executing processes. Based on the changing usage, the controller 220 may change the number of top executing processes, allowing more or less processes to concurrently execute. Thus, an entry 252 for a process may become a member, or cease to become a member, of the top executing processes. Accordingly, each process is suspended or re-started accordingly.

With reference back to FIG. 3, the server device also contains a command queue 350 controlled by the data manager or controller 320. However, in one embodiment of the command queue 350 of the server device 30, the entries 352 are not sorted by priority, but by bandwidth requirement or system usage for particular types of processes. In this embodiment, the server device 30 may optimize specific transmissions based on certain metrics, for example, by adjusting the size of the file portions 262 transmitted based on system resources, but the server device 30 may not suspend and re-start downloading of individual files 260. However, the controller 220 of the server device 30 suspends all connections that meet certain criteria, such as required bandwidth for a certain class of processes. For example, transmissions of high resolution video files and the like may be suspended if server resources become scarce due to an upsurge in user transactions during business hours. The controller 320 may, for example, allow more transient dial-up connections during a high usage time, serving the broadband customers at a later, lower-usage volume time.

The entries 352 are added to the queue 350 as described above with respect to the command queue 250 of the client device 10. However, in the server device 30, each entry 352 is assigned a type based on the related process for that entry 352. For example, some of the types that may be assigned to each entry 252 include, without limitation: media file download, text file download, high bandwidth on-line video game play, low bandwidth financial transaction (e.g. stock trade), etc. If the system resources for the server device fall below a certain level, then a type is selected for suspending processing from a matrix 392 stored in the non-volatile storage device 304 and in the volatile storage device 300 during operation. The types of entries 352 that are selected for suspension would be those high-bandwidth process types that tend to tie up system resources much more significantly than low bandwidth processes. The high bandwidth processes may be continued, for example, in the late evenings when the low bandwidth transactions subside, which the controller 320 coordinates by detecting the reduced usage of system resources for the server device 30, and then releasing those types of entries 352 for continuing processing of their related processes.

As an example, with respect to the file transfer procedure described above with respect to the client device 10, the file 260 stored on the server device 30 for which portions 262 are being transmitted to the client device 10, may be suspended by the controller 320 of the server 30. In that case, the server device 30 suspends transmission of the portions 262, and sends a notification to the client device 10, the controller 220 of which receives the notification. The controller 220 of the client device correspondingly suspends processing the entry 252 in the command queue 250 corresponding to the notification. The controller 220 may then poll the server device 30 periodically until the controller 320 of the server device 30 releases the processes for the types that were suspended.

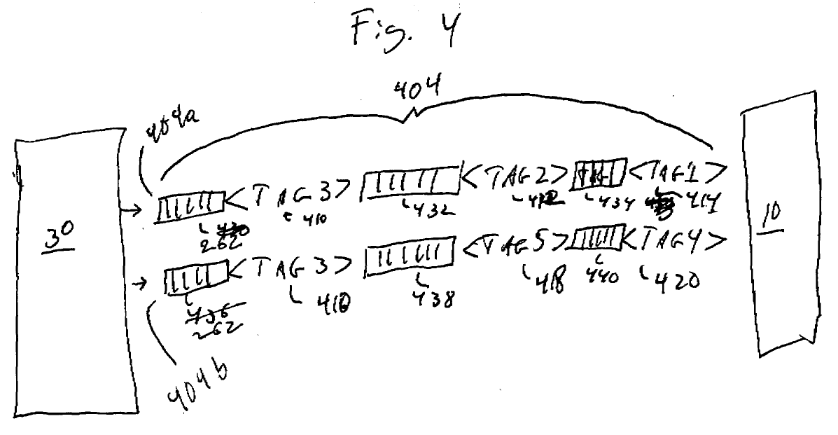

With reference to FIG. 4, a block diagram illustrating a packetized protocol that can be used for communication between a sever device 30 and a client device 10 is shown. For communications between the server device 30 and the client device 10, packets 404 may be used. Preferably, the packets 404 may be of the tagged type, wherein portions of each packet 404 contain tags 410-420 for identifying corresponding data elements 262, 432-434, 438 and 440 containing data. The packets 404 may use an extensible markup language (XML) format. XML is used for defining data elements in XML documents. It uses a similar tag structure as HTML. However, whereas HTML defines how elements are displayed, XML defines what those elements contain. HTML uses predefined tags, but XML allows tags to be defined by the programmer of the XML document. Thus, virtually any data items can be identified in XML. The system of the present invention may form packets 404 that are formatted as XML documents.

The data elements 262, 432-434, 438 and 440 may not necessarily be related. While the data element 434 identified by <TAG1>414 may be related to a Microsoft WORD document that is being downloaded from the server device 30, the data element defined by <TAG2>412 may contain data related to a graphics image being downloaded. In FIG. 4, two packets 404a and 404b that are transferred from the server device 30 to the client device 10 are shown. The first packet 404a contains three tags 410-414 with corresponding data elements 262, 432 and 434. Data elements 430 and 432 comprise data unrelated to the data element 262, which is a portion 262 of a file 260 being transferred from the server device 30 to the client device 10. The second packet 404b contains further data elements 438 and 440 identified by tags 418 and 420 respectively. However, the second packet 404b also contains a portion 262 of the file 260 being transferred, identified by the same tag 410. When either of the controllers 220 or 320 cause the transfer of the file portions 262 to suspend or stop, the data elements 262 and tags 410 are not included in any packets 404 that are transmitted, thereby interrupting transmission of the file 260. Once transfer is re-started, data elements 262 and tags 410 are again included in the packets 404 being transmitted. At the client 10, the controller 220 parses the packets 404 according to the tags 410-414, 418 and 420 into the separate data elements 262, 432-434, 438 and 440.

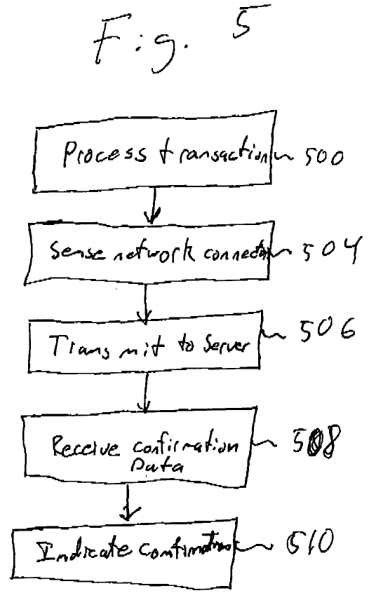

With reference to FIG. 5, a flow diagram illustrating steps performed by the client device 10 for completing a transaction is shown. At step 500, processing a transaction may be completed either off-line or on-line to create completed transaction data 290. The client device 10 then senses a network connection to the network 20, step 504. The completed transaction data 290 is transmitted to the server device 30 when the network connection is sensed, step 506. After processing by the server device 30, if any, the client device 10 receives confirmation data 390 from the server device 30 indicating that a server device 30 received the completed transaction data 290, step 508. The confirmation data 390, or an indicator that the confirmation data 390 was received, is output to indicate to a user that the completed transaction data 290 was received by the server device 30.

With reference back to FIG. 1, the systems and methods described above may be used and integrated with a system and method for discouraging unauthorized duplication of data stored on a storage media 120a. The storage media 120a may contain one or more data files 122 stored on the storage media 120a. The data files 120a are capable of being read by a storage media reader 102a contained in or connected to one of the client devices 30a.

However, digital storage media 120a is inherently easy to duplicate, to create an exact copy 120b that is not discernable from the original 120a. Such duplicates 120b may be unauthorized. For example, the data files 122 may be copyrighted material produced by a software or music company. After duplication, it is possible for another client device 30b with a storage media reader 102b to read the unauthorized copy of the storage media 120b. As described above with respect to the network data, the client devices 30a and 30b may receive updated network data from a server device 10 as a result of using the storage media containing the data files 122, wherein the network 20 is connected to a plurality of client devices 30, 30a and 30b.

To prevent the downloading of the updated network data to more than one client 30a and 30b after unauthorized duplication, an identification number 124 stored on the storage media 120a and 120b is transmitted to the server device 10 to notify the server device 10 that only the last client device 30a or 30b that transmitted the identification number in time should receive updated network data. The client device 30a or 30b not receiving the updated network data may display a message notifying the user of the client device 30a or 30b that an unauthorized duplication was detected, and therefore, there is updated network data that was not received from the server device 10. This gives the legitimate user the opportunity to communicate with the copyright holder of the data files 122 if the unauthorized duplication was committed without their knowledge or approval.

One example where this system and method may have a significant impact is in music CD technology, wherein wide spread unauthorized duplication of music CDs have been well publicized. In the case where the storage media 120a is a music CD, the data files 122 may comprise music files capable of being played on the client devices 30a and 30b. In order to discourage duplication, the music publisher may offer special updated network data to what should be the rightful owner of the music CD 120a. The updated network data may comprise data for enhanced presentation of the music files 122. Examples of the updated network data comprises advanced concert ticket sale offers, movie previews, digital music videos that can be displayed on the client device 30a while the music files 122 are played, promotional data, and other updated network data for presentation or use by the client device 30a as a result of the music CD 120a purchase. Only the user who's client device 30a transmitted the identification number 124 to the server device 10 last in time receives the updated network data, the other client device 30b receiving a message that the updated network data was not received.

Alternatively, the sever device 10 may cut off all transmissions to the client devices 30a and 30b, providing the aforementioned message indicating so, if the identification number 124 is received from two different client devices 30a and 30b. It would then be up to the users of those client devices 30 and 30b to contact the music publisher and show that they are the rightful owner of the storage media 120a if they desire updated network data. The music publisher may choose to send a new music CD 120a with a new identification number 124 stored thereon to the rightful owner of the music CD, cutting off transmission to the client device 30b using the unauthorized duplicate storage media 120b having the old identification number 124. Tracking of which client device from which the identification number 124 is received can be done by using cookies or network identifiers from the client devices 30a and 30b.

The server device 10 contains an authorization system comprising software stored on the server device 10 for authorizing transmission of updated network data to only the client device 30a or 30b that last in time transmitted the identification number 124. A database 154 is used to store the identification numbers 124 for each media device 120a. When received from a client device 30a, the identification number 124 is matched in the database 154, and time stamps may be stored to keep track of the time that each client device 30a or 30b transmitted an identification number 124, and to handle duplicate transmissions of identification numbers 124.

Alternatively to discouraging duplication of music CDs, the system may be used to discourage duplication of many other types of media, such as software programs, operating systems, user data, video files, and any other digital content for which updated network data may be helpful or desirable to the user. For example, a software program may have an expiration date, for which the updated network data is needed in order for the program to continue to be used on the client device 30a or 30b after the expiration date. As described above, icons may change character or audio signals may be used to indicate that the updated network data was received.

Although the invention has been described in terms specific types of elements, as well as with reference to certain methodological acts, it is to be understood that the invention defined in the appended claims is not necessarily limited to the specific structures or acts described. The specific structural features and acts therefore are disclosed as exemplary embodiments implementing the claimed invention.

Further, the embodiments described above are provided by way of illustration only and should not be construed to limit the invention. Those skilled in the art will readily recognize various modifications and changes that may be made to the present invention without following the exemplary embodiments and applications illustrated and described herein, and without departing from the scope of the present invention, which is set forth in the following claims.

What is claimed is:

1. A system for discouraging unauthorized duplication of data stored on a storage media, comprising:
(a) the storage media;
(b) one or more data files stored on the storage media, the data files being capable of being read by a storage media reader of a client device; and
(c) an identification number stored on the storage media for transmitting to a server device to notify the server device that only the client device should receive updated network data.

2. The system of claim 1, wherein the client device comprises one of plurality of client devices on a network, and wherein only the last client device to transmit the identification number in time receives the updated network data.

3. The system of claim 2, wherein the data files comprise one or more music files capable of being played by the client device.

4. The system of claim 3, wherein the updated network data comprises data for enhanced presentation of the one or more music files.

5. The system of claim 4, wherein the enhanced presentation comprises one or more music video presentations to be presented while the one or more music data files are played.

6. The system of claim 2, wherein the updated network data comprises data for presenting promotional data on the client device.

7. A system for discouraging unauthorized duplication of data stored on a storage media, comprising:
(a) a server device capable of receiving an identification number that is stored on a storage media that is read by a client device; and
(b) an authorization system stored on the server device for authorizing transmission of updated network data to only the client device that last in time transmitted the identification number.

8. In a client device, a method for discouraging unauthorized duplication of data stored on a storage media, comprising:
(a) reading an identification number stored on the storage media, the storage media further for storing data files; and
(b) transmitting the identification number to a server device to notify the server device that only the client device should receive updated network data.

9. The method of claim 8, wherein the client device comprises one of plurality of client devices on a network, comprising only the last client device in time that transmits the identification number receives the updated network data.

10. The method of claim 9, wherein the data files comprise one or more music files capable of being played by the client device.

11. The method of claim 10, wherein the updated network data comprises data for enhanced presentation of the one or more music files.

12. The method of claim 11, wherein the enhanced presentation comprises one or more music video presentations to be presented while the one or more music data files are played.

13. The method of claim 9, wherein the updated network data comprises data for presenting promotional data on the client device.

14. In a server device, a method for discouraging unauthorized duplication of data stored on a storage media, comprising:
(a) receiving an identification number that is stored on a storage media that is read by a client device; and
(b) authorizing transmission of updated network data to only the client device that last in time transmitted the identification number.
